(19) United States
(12) Patent Application Publication
(10) Pub. No.: US 2004/0128879 A1
(43) Pub. Date: Jul. 8, 2004

(54) Display apparatus

(76) Inventor: Chia Ping Lu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/739,167

(22) Filed: Dec. 19, 2003

(30) Foreign Application Priority Data
Jan. 3, 2003 (TW) 092200062

(51) Int. Cl. G09F 13/00

(52) U.S. Cl. 40/442

(57) ABSTRACT

This invention relates to a display apparatus which comprises the transparent container has at least one open end and a space. The jelly layer and the max layer are filled in the transparent container. The upper of the transparent container is the max layer which can seal up the jelly layer so that the liquid in the jelly layer won't permeate or evaporate. The jelly layer is used to display the floating decoration. The max layer has the candlewick thereon to display the decoration by using the projected candlelight and lamplights to enhance the practical and ornamental functions. A lighting device can be placed under the display apparatus to display another scene trough the various layers of light.

### BACKGROUND OF THE INVENTION

(1) Field of the Invention

This invention relates to a display apparatus, and more specifically to a display apparatus that can be used to display the three-dimensional decoration through the various layers of lights.

(2) Description of Related Art

With the development of domestic and overseas economies, the standard of living has been raised in the recent years. This new product will serve as a practical and multi-functional role so as to promote a better appreciation of the natural environment.

It will magnify the beauty of any exhibit and inspire the spiritual consciousness of the viewer. It will show the exhibit in a delicate beauty and unique taste, an aspect that is used in interior decorating.

Traditional ways of displaying are usually dull and boring, but in contrast, the use of lighting can make a difference. The soft and gleaming candlelight can enhance the visual effect of the exhibit and thus bring out its functional and ornamental characteristics.

Traditionally, people have used boxes or bags to store or display their jewelry—gems, jade, and crystals. Traditional displays are limited in the following ways:

(1) Fixed displays lack diverse enhancements.

(2) Limited space of displays restricts the observation angle of view.

(3) Contact with human skin can damage the exhibit.

(4) The color of the exhibit cannot be enhanced.

### SUMMARY OF THE INVENTION

It is an objective of the present invention to provide a display apparatus that uses the transparent container filled with the jelly layer and the max layer. At least one decoration is placed in the transparent container to display the three-dimensional decoration.

It is another objective of the present invention to provide a display apparatus in which the decoration is floating in the transparent container to display another three-dimensional scene. The jelly layer is comprised of the mixture of the polymer absorbent jelly grain and the liquid.

It is still another objective of the present invention to provide a display apparatus used to display the decoration by using the projected candlelight and lamplights to enhance the practical and ornamental functions.

In accordance with the present invention, a display apparatus is described in which the display apparatus comprises the jelly layer and the max layer. The wax layer can seal up the jelly layer so that the liquid in the jelly layer won't permeate or evaporate. The floating decoration in the jelly layer and the candlewick on the wax layer can display the beauty of the various layering lights.

This invention has been summarized above and described with reference to the preferred embodiments. Some processing details have been omitted and are understood by those skilled in the art. More details of this invention are stated in the “DESCRIPTION OF THE PREFERRED EMBODIMENTS” section.

### BRIEF DESCRIPTION OF THE DRAWINGS

The object and other advantages of this invention are best described in the preferred embodiments with reference to the attached drawings that include:

FIG. 1 is a perspective view of the display apparatus in accordance with a first embodiment of the present invention;

FIG. 1A is an enlarged side view in FIG. 1;

FIG. 2 is a cross-sectional view of the display apparatus in accordance with a first embodiment of the present invention;

FIG. 2A is an enlarged side view in FIG. 2;

FIG. 3, which in cross-sectional representation illustrates the display apparatus in accordance with a second embodiment of the present invention; and

FIG. 4, which in cross-sectional representation illustrates the display apparatus in accordance with a third embodiment of the present invention.

### DESCRIPTION OF THE PREFERRED EMBODIMENTS

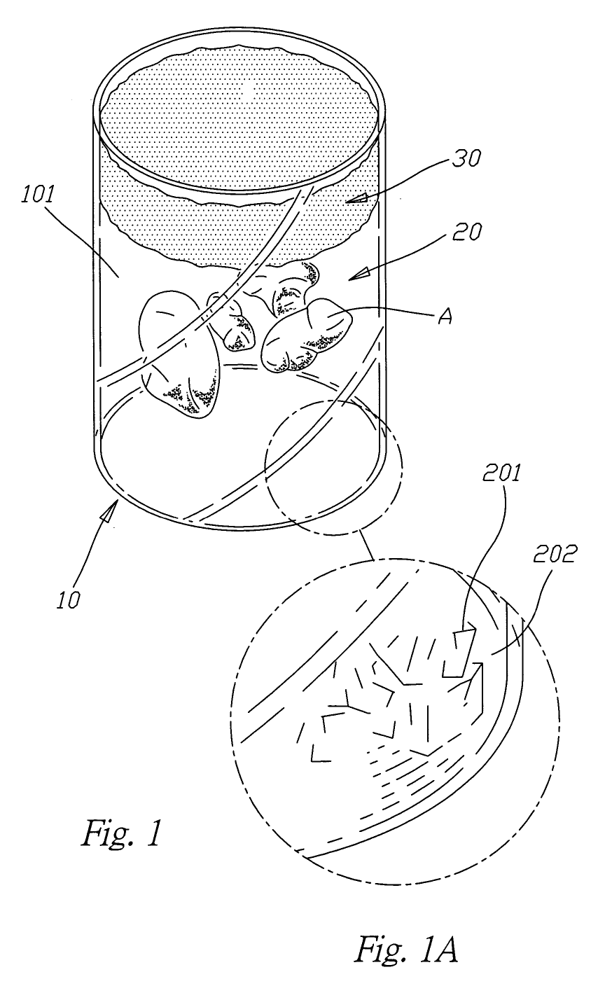

Referring to FIG. 1 and FIG. 1A, there is shown the display apparatus of the present invention. The display apparatus comprises: a transparent container 10, a jelly layer 20, and a max layer 30. The Transparent container 10 has at least one open end and a space 101 therein for containing the jelly layer 20 and the max layer 30. The jelly layer 20, which is transparent or translucent, is the mixture of the polymer absorbent jelly grain 201 and the water 202 to be able to float the decoration A therein. The max layer 30 is the material of max formed on the top of the jelly layer 20. The max layer 30 can be used to seal the jelly layer 20 to cover the jelly grain 201 in the jelly layer 20 and to prevent the water 202 from evaporating.

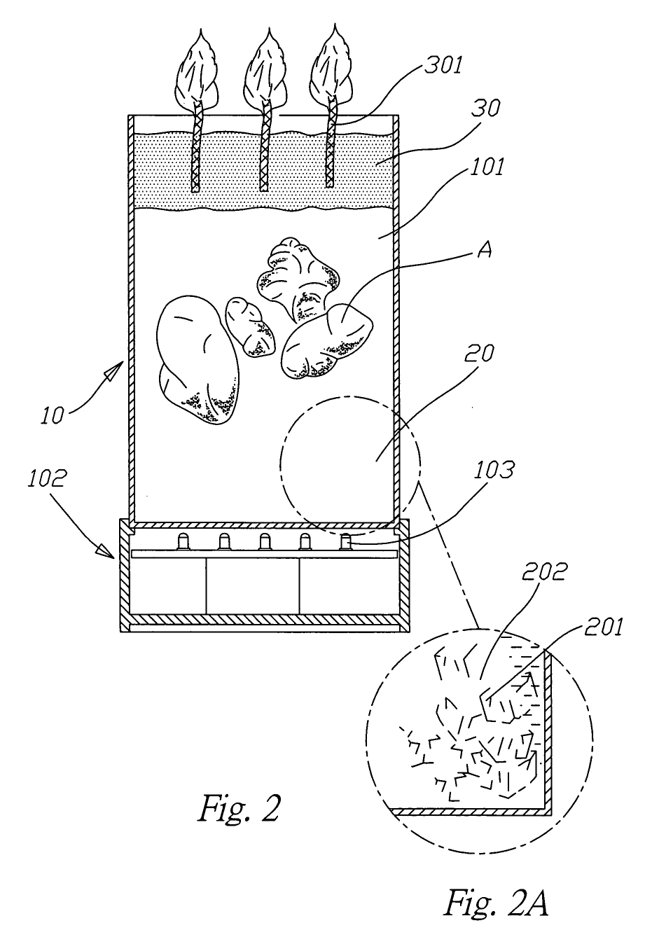

Referring to FIG. 1, FIG. 1A, FIG. 2 and FIG. 2A, the display apparatus comprises a candlewick 301 formed on the max layer 30. Further, the display apparatus comprises a lamp base 102 under the transparent container 10. The lamp base 102 has the lamp 103 therein to be able to display the three-dimensional scene through the candlelight and the light of the lamp projected in the jelly layer 20.

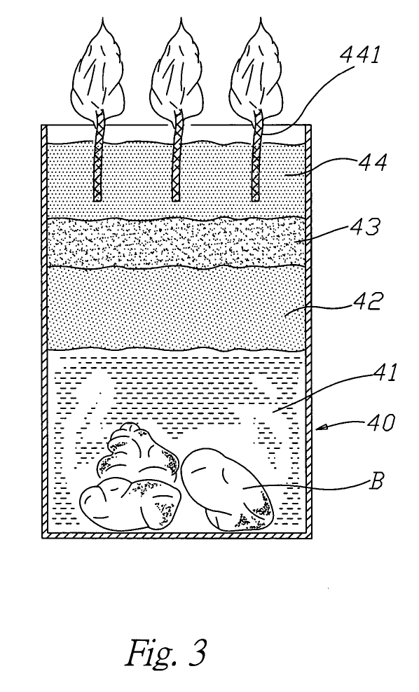

Referring to FIG. 3, there is shown the second embodiment of the present invention, which comprises a transparent container 40, a liquid layer 41, a wax layer 42 and the a jelly layer 43. The liquid layer 41 has the decoration B therein. The max layer 42 is formed on the top of the liquid layer 41 to separate from the jelly layer 43. The jelly layer 43 is formed on the top of the max layer 42 to support the max layer 44. Further, a candlewick 441 is formed on the max layer 44 to display the three-dimensional scene through the candlelight.

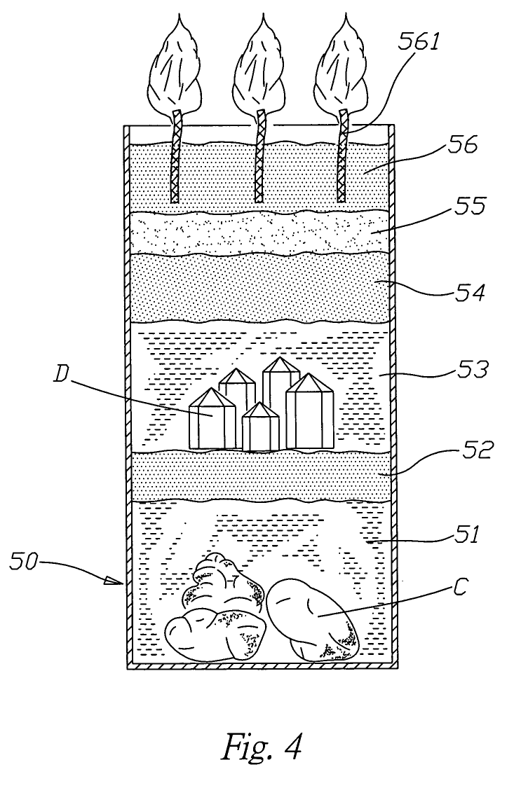

Referring to FIG. 4, there is shown the third embodiment of the present invention, in which the transparent container 50 from top to bottom includes the liquid layer 51, the wax layer 52, the liquid layer 53, the wax layer 54, the jelly layer 55, and the wax layer 56. The liquid layer 51 and the liquid layer 53, respectively, have the decorations C and D. The liquid layer 51 and 53 are separated by the max layer 52 to support the upper layers. Further, a candlewick 561 is formed on the max layer 56 to display anther scene through the various lights. Any of the liquid layers 51 and 53 can be replaced to the jelly layer. That is, the combination of a max layer and a jelly layer are formed under the jelly layer 55. Alternatively, the combination of a max layer, a liquid layer and a jelly layer are formed under the jelly layer 55.

Described in the figures is a display apparatus, which is used to display the floating decoration in the transparent container through the transparent jelly layer. It is not only used to display the candlelight scene, but also used to extinguish the fire of candle until the fire of candle is reached the jelly layer having the water. Further, a lighting device can be placed under the display apparatus to display another scene trough the various layers of light.

While the invention has been particularly shown and described with reference to the preferred embodiments thereof, it will be understood by those skilled in the art that various changes in form and details may be made without departing from the spirit and scope of the invention.

What is claimed is:

1. A display apparatus, comprising:
a transparent container, having at least one open end and a space;
a jelly layer formed in said transparent container; and
a wax layer formed on said jelly layer in said transparent container to seal said jelly layer.

2. The display apparatus of claim 1, wherein said max layer has at least one candlewick.

3. The display apparatus of claim 1, wherein a lighting device is placed under or side of said transparent container.

4. The display apparatus of claim 1, wherein said jelly layer is comprised of the mixture of the polymer absorbent jelly grain and the liquid.

5. The display apparatus of claim 1, wherein at least one decoration is floating in said jelly layer.

6. The display apparatus of claim 1, wherein a wax layer and a liquid layer are formed below said jelly layer.

7. The display apparatus of claim 6, wherein one decoration is placed in said liquid layer.

8. The display apparatus of claim 1, wherein the wax layers and the liquid layers are formed below said jelly layer by the sequence of forming said wax layer and said liquid layer repeatedly.

9. The display apparatus of claim 8, wherein at least one liquid layer is a jelly layer.

10. The display apparatus of claim 9, wherein at least one decoration is in said jelly layer.

11. The display apparatus of claim 8 or 9, wherein at least one decoration is in said liquid layer.

12. The display apparatus of claim 9, wherein at least one decoration is in said liquid layer and in jelly layer, respectively.

13. The display apparatus of claim 1, wherein said max layer is jelly wax.
